(19) United States
(12) Patent Application Publication
(10) Pub. No.: US 2021/0081294 A1
(43) Pub. Date: Mar. 18, 2021

(54) PROCESSING SCREENSHOTS OF AN APPLICATION USER INTERFACE TO DETECT ERRORS

(71) Applicant: TestRigor, Inc., San Francisco, CA (US)

(72) Inventor: Artem Golubev, San Francisco, CA (US)

(21) Appl. No.: 17/017,395

(22) Filed: Sep. 10, 2020

Related U.S. Application Data
(60) Provisional application No. 62/900,171, filed on Sep. 13, 2019.

(51) Int. Cl. G06F 11/34; G06K 9/62; G06N 3/04; G06F 11/30; G06F 11/32

(52) U.S. Cl. CPC G06F 11/349; G06K 9/6256; G06F 11/327; G06F 11/3089; G06F 11/3461; G06N 3/0454

(57) ABSTRACT

A technique is introduced for detecting errors and other issues in an application graphical user interface (GUI) by applying machine learning to process screenshots of the GUI. In an example embodiment, the introduced technique includes crawling a GUI of a target application as part of an automated testing process. As part of the crawling, an executing computer system can interact with various interactive elements of the GUI and capture various screenshots of the GUI that depict the changing state of the GUI based on the interaction. These screenshots can then be processed using one or more machine learning models to detect errors and/or other issues with the GUI of the application. In some embodiments, the machine learning models can be trained using previously captured and labeled screenshots from other application GUIs.

### CROSS-REFERENCE TO RELATED APPLICATIONS

This application claims the benefit of U.S. Provisional Application No. 62/900,171 titled, “PROCESSING SCREENSHOTS OF AN APPLICATION USER INTERFACE TO DETECT ERRORS,” filed on Sep. 13, 2019, the contents of which are hereby incorporated by reference in their entirety for all purposes. This application is therefore entitled to a priority date of Sep. 13, 2019.

### BACKGROUND

Newly developed software applications typically require extensive testing to eliminate bugs and other errors before deployment for access by end users. In practice, the testing of user interfaces associated with applications can be particularly challenging. Several approaches have been implemented to test the user interface functionality of applications. A traditional approach involves the use of human quality assurance (QA) testers to manually interact with an application to identify bugs and other errors. Manual QA testing can be expensive and time consuming and can lead to inconsistent results since human testers are prone to mistakes. To address some shortcomings of manual testing, several tools (e.g., Selenium™, Appium™, and Calabash™) have been developed to automate the process. While existing automation tools can alleviate the need for extensive manual testing, such tools can present new issues. For example, existing automated testing tools require continued support to ensure that the automated tests still work within a framework of an application being tested. For example, if the framework of an application changes (e.g., in an updated version), a program for performing an automated test of the application will itself need to be updated. Further, both manual testing and existing automation tools typically provide poor testing coverage since they are limited by existing knowledge of the functionality of the application. Human QA testers will usually only cover what is described in a defined test case. Similarly, existing automation tools will only cover what is defined in their automation scripts.

### BRIEF DESCRIPTION OF THE DRAWINGS

FIG. 1 is a block diagram illustrating an example networked computing environment in which certain embodiments of the introduced technique can be implemented;

FIG. 2 is a block diagram illustrating another example computing environment in which the introduced technique can be implemented;

FIG. 3 is a block diagram illustrating a high-level architecture of an example automated testing platform;

FIG. 4 is a block diagram illustrating a high-level architecture of an example machine learning module of the automated testing platform of FIG. 3;

FIG. 5 is an architecture flow diagram illustrating an example automated testing process;

FIG. 6 is a flow diagram illustrating an example process for applying a machine learning diagnostic model to process one or more captured screenshots of a target application graphical user interface (GUI) to generate a diagnostic output;

FIG. 7A shows an example screenshot of a target application GUI while operating normally;

FIG. 7B shows an example screenshot of the same target application of FIG. 7A, while not operating abnormally;

FIG. 8 is an architecture flow diagram illustrating a first example automated testing process that includes processing captured screenshots using one or more machine learning models;

FIG. 9 is an architecture flow diagram illustrating a second example automated testing process that includes processing captured screenshots using one or more machine learning models;

FIG. 10 is a flow diagram illustrating an example process for using a machine learning diagnostic model to detect errors or other issues in a GUI of a target application;

FIG. 11 is an architecture flow diagram illustrating an example process for training and deploying a machine learning diagnostic model;

FIGS. 12-20 show a series of screens associated with an example GUI associated with an automated testing platform.

### DETAILED DESCRIPTION

### Overview

Automated application testing has several benefits over more traditional manual approaches. However, existing automation tools are still limited in their ability to detect errors or other issues in an application during testing. Detecting errors in a graphical user interface (GUI) of an application can be particularly challenging, for example, because such errors may be transient in nature (i.e., appearing temporarily during a user interaction flow) and because such errors may in some cases be non-functional in nature and based on human perception. For example, a human QA tester may be able to evaluate whether a set of interactive elements appear in a correct manner on a page of an application GUI; however, this same task may be exceedingly difficult for an automated system to detect.

To address these challenges and the limitations of exiting automation tools, a technique is introduced for detecting errors and other issues in an application GUI by applying machine learning to process screenshots (also referred to herein as “screen captures”) of the GUI. In an example embodiment, the introduced technique includes crawling a GUI of a target application as part of an automated testing process. As part of the crawling, an executing computer system will interact with various interactive elements of the GUI and capture various screenshots of the GUI that depict the changing state of the GUI based on the interaction. These screenshots can then be processed using one or more machine learning models to detect errors and/or other issues with the GUI of the application. In some embodiments, the machine learning models can be trained using previously captured and labeled screenshots from other application GUIs.

### Automated Testing Platform

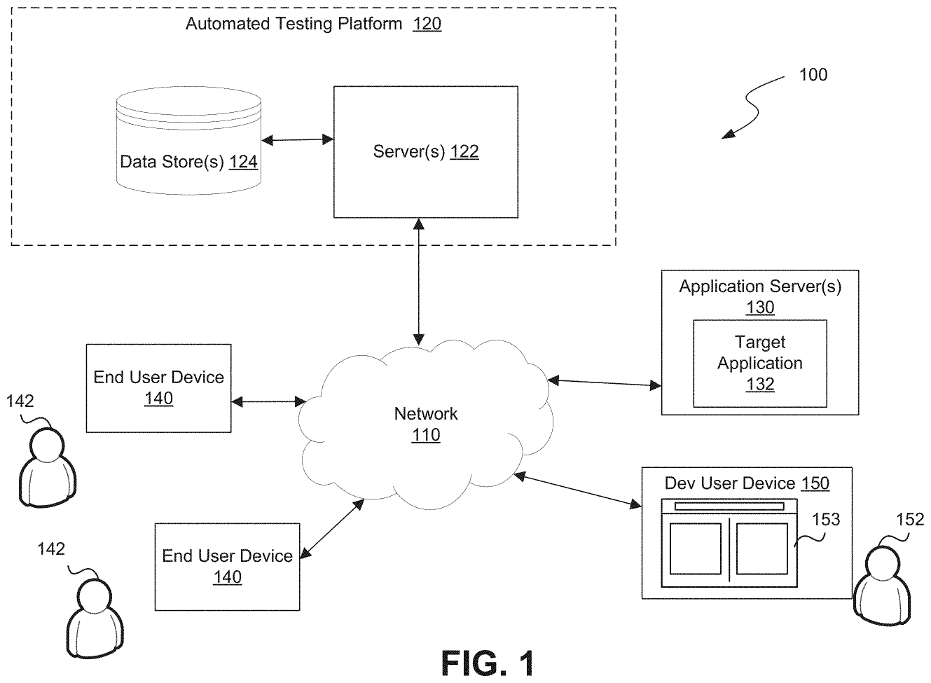

FIG. 1 is a block diagram illustrating an embodiment of a networked computing environment 100 in which certain embodiments of the introduced technique can be implemented. As shown in FIG. 1, the example networked computing environment 100 includes an automated testing platform 120 for performing automated testing of a target application 132, according to the introduced technique.

The example networked computing environment 100 depicted in FIG. 1 includes a network 110 over which various network-connected computing devices and systems are capable of communicating. Network 110 can include a single distinct network or can include a collection of distinct networks operating wholly or partially in conjunction to provide connectivity between network-connected computing systems. For example, network 110 may include one or more of a wired or wireless local area network (LAN), a wired or wireless wide area network (WAN), a cellular data network, or any other appropriate communication network. Further, the one or more networks can include open networks (e.g., the Internet) and/or private networks (e.g., an intranet and/or an extranet). Communication between network-connected computing systems over network 110 may be over any known communication protocol or model such as the Internet Protocol Suite (i.e., TCP/IP), the Open System Interconnections (OSI) model, the User Datagram Protocol (UDP), the File Transfer Protocol (FTP), etc.

The automated testing platform 120 may include one or more server computer systems 122 with processing capabilities for performing embodiments of the introduced technique. The automated testing platform 120 may also include non-transitory processor-readable storage media or other data storage facilities for storing instructions that are executed by a processor and/or storing other data utilized when performing embodiments of the introduced technique. For example, the automated testing platform 120 may include one or more data store(s) 124 for storing data. Data store 124 may represent any type of machine-readable capable of storing structure and/or unstructured data. Data stored at data store 124 may include, for example, image data (e.g., screenshots), video data, audio data, machine learning models, testing scenario data, recorded user interaction data, testing files (e.g., copies of a target application), etc. Note that the term “data store” is used for illustrative simplicity to refer to data storage facilities, but shall be understood to include any one or more of a database, a data warehouse, a data lake, a data mart, data repository, etc.

While illustrated in FIG. 1 as a single server computer system 122 and associated data store 124, many implementations may employ two or more server computer systems 122 and/or data stores 124. Further, the server computer systems 122 depicted in FIG. 1 may represent physical computing devices and/or virtualized devices instantiated at one or more physical computing devices at a single physical location or distributed at multiple physical locations. Similarly, data store 124 may represent multiple data stores, each of which may be distributed across multiple physical computing devices.

In some embodiments, certain components of automated testing platform 120 may be hosted or otherwise provided by separate cloud computing providers such as Amazon™ Web Services (AWS) or Microsoft Azure™. For example, AWS provides cloud-based computing capabilities (e.g., EC2 virtual servers), cloud-based data storage (e.g., S3 storage buckets), cloud-based database management (e.g., DynamoDB™), cloud-based machine-learning services (e.g., SageMaker™), and various other services. Other cloud computing providers provide similar services and/or other cloud-computing services not listed. In some embodiments, the components of automated testing platform 120 may include a combination of components managed and operated by a provider of the automated testing platform 120 (e.g., an internal physical server computer) as well as other components managed and operated by a separate cloud computing provider such as AWS™.

The automated testing platform 120 can be implemented to perform automated testing of a target application 132. The target application 132 may include any type of application (or app) configured to run on personal computers (e.g., for Windows™, MacOS™, etc.), applications configured to run on mobile devices (e.g., for Apple™ iOS, Android™, etc.), web applications, websites, etc. In some embodiments, the automated testing platform 120 is configured to perform automated testing of various GUI functionality associated with a target application 132. For example, in the case of a website with interactive elements, automated testing platform 120 may be configured to test the interactive elements associated with the website as presented via one or more different web browser applications.

The target application 132 can be hosted by a network system connected to network 110 such as an application server 130. In the case of a website, application server 130 may be referred to as a web server. In any case, as with server 122, application server 130 may represent a single physical computing device or may represent multiple physical and/or virtual computing devices at a single physical location or distributed at multiple physical locations.

Various end users 142 can access the functionality of the target application 132, for example, by communicating with applications server 130 over network 110 using a network-connected end user device 140. An end user device 140 may represent a desktop computer, a laptop computer, a server computer, a smartphone (e.g., Apple iPhone™), a tablet computer (e.g., Apple iPad™), a wearable device (e.g., Apple Watch™), an augmented reality (AR) device (e.g. Microsoft Hololens™), a virtual reality (VR) device (e.g., Oculus Rift™), an internet-of-things (IOT) device, or any other type of computing device capable of applying the functionality of target application 132. In some embodiments, end users 142 may interact with the target application via a GUI presented at the end user device 140. In some embodiments, the GUI through which the user 142 interacts with the target application 132 may be associated with the target application 132 itself or may be associated with a related application such as a web browser in the case of a website. In some embodiments, interaction by the end user 142 with the target application 132 may include downloading the target application 132 (or certain portions thereof) to the end user device 140.

A developer user 152 associated with the target application 132 (e.g., a developer of the target application 132) can utilize the functionality provided by automated testing platform 120 to perform automated testing of the target application 132 during development and/or after the target application has entered production. To do so, developer user 152 can utilize interface 153 presented at a developer user device 150, for example, to configure an automated test, initiate the automated test, and view results of the automated test. Interface 153 may include a GUI configured to receive user inputs and present visual outputs. The interface 153 may be accessible via a web browser, desktop application, mobile application, or over-the-top (OTT) application, or any other type of application at developer user device 150. Similar to end user devices 140, developer user device 150 may represent a desktop computer, a laptop computer, a server computer, a smartphone, a tablet computer, a wearable device, an AR device, a VR device, or any other type of computing device capable of presenting interface 153, and/or communicating over network 110.

Although the networked computing environment 100 depicted in FIG. 1 shows only one developer user 152 and one target application 132 for testing, in some embodiments, multiple different developer users associated with multiple different target applications may access the automated testing functionality of automated testing platform 120. For example, the various functionalities associated with automated testing platform 120 may be provided to various application developers as a service to test their respective applications during development and/or after entering production. In some embodiments, automated testing services may be provided by the automated testing platform 120 for a one-time and/or subscription fee. Developer users signing up for the automated testing services may access such services by connecting, for example, via network 110 to the automated testing platform 120. In other words, in some embodiments, automated testing services can be provided to the developer users without downloading or installing any software to a computing system associated with or managed by the respective developer users.

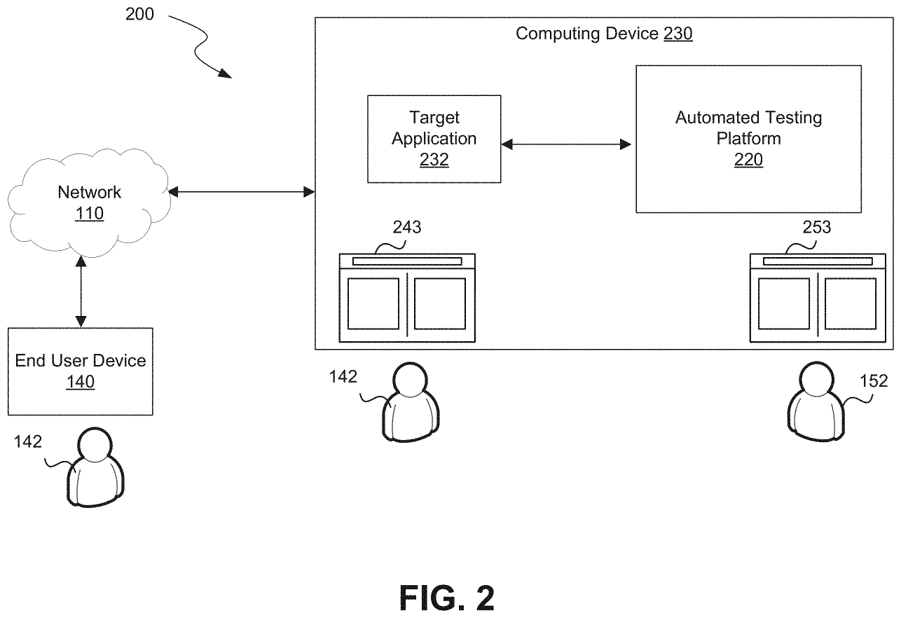

FIG. 1 depicts an automated testing platform 120 in the context of a networked computing environment 100; however, the introduced technique is not limited to such a context. In some embodiments, one or more components of automated testing platform 120 may be instantiated locally at a computing device that hosts the target application. For example, FIG. 2 depicts an alternative computing environment 200 in which the introduced technique can be implemented. As shown in FIG. 2, a computing device 230 hosts both the target application 232 (analogous to target application 132) as well as the automated testing platform 220. In this example, automated testing platform 220 may represent software installed at computing device 220. In other words, target application and automated testing platform 220 may share the common computing hardware (e.g., memory, processor, storage, etc.) of computing device 230 although they may be implemented in different virtual machines instantiated at computing device 230. End users 142 may access the functionally of target application 232 locally, for example, via interface 243 and/or remotely via network 110 using a network-connected end user device 140. Further, the developer user 152 may interact with the automated testing platform 220 via interface 253 (analogous to interface 153), for example, to configure an automated test, initiate the automated test, and view results of the automated test.

One or more of the devices and systems described with respect to FIGS. 1-2 (e.g., automated testing platform 120, application server 130, end user devices 140, developer user device 150, computing device 230, etc.) may be implemented as computer processing systems. As used herein, a “computer processing system” may include one or more processors (e.g., central processing units (CPU), graphical processing units (GPU), etc.) that are coupled to one or more memory (e.g., volatile and/or non-volatile) that store instructions that can be executed using the one or more processors to perform operations associated with the introduced technique. A computer processing system may further include one or more storage media such as hard disk drives (HDD), solid state drives (SSD), and/or removable storage media (e.g., Compact Disc Read-Only Memory (CD-ROM)). The memory and storage media may be collectively referred to herein as non-transitory computer-readable (or machine-readable) media. Such non-transitory computer-readable media may include single devices or may include system of multiple devices at different physical locations (e.g., distributed databases).

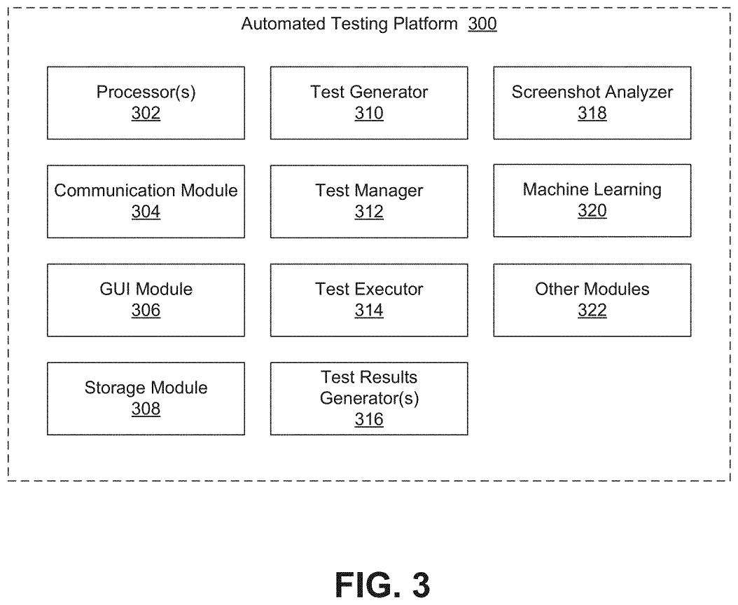

FIG. 3 is a block diagram illustrating a high-level architecture of an example automated testing platform 300. Example automated testing platform 300 may be the same or similar to automated testing platform 120 depicted in FIG. 1 and automated testing platform 220 depicted in FIG. 2. As shown in FIG. 3, automated testing platform 300 includes one or more processors 302, a communication module 304, a GUI module 306, a storage module 308, a test generator module 310, a test manager module 312, a test executor module 314, a test results generator module 316, a screenshot analyzer module 318, a machine learning module 320, and may include other modules 322.

Each of the modules of example automated testing platform 300 may be implemented in software, hardware, or any combination thereof. In some embodiments, a single storage module 308 includes multiple computer programs for performing different operations (e.g., metadata extraction, image processing, digital feature analysis), while in other embodiments each computer program is hosted within a separate storage module. Embodiments of the automated testing platform 300 may include some or all of these components, as well as other components not shown here.

The processor(s) 302 can execute modules from instructions stored in the storage module(s) 308, which can be any device or mechanism capable of storing information. For example, the processor(s) 302 may execute the GUI module 306, a test generator module 310, a test manager module 312, a test executor module 314, etc.

The communication module 304 can manage communications between various components of the automated testing platform 300. The communication module 304 can also manage communications between a computing device on which the automated testing platform 300 (or a portion thereof) resides and another computing device.

For example, the automated testing platform 300 may reside one or more network-connected server devices. In such embodiments, the communication module 304 can facilitate communication between the one or more network-connected server devices associated with the platform as well as communications with other computing devices such as an application server 130 that hosts the target application 132. The communication module 304 may facilitate communication with various system components through the use of one or more application programming interfaces (APIs).

The GUI module 306 can generate the interface(s) through which an individual (e.g., a developer user 152) can interact with the automated testing platform 300. For example, GUI module 306 may cause display of an interface 153 at computing device 150 associated with the developer user 152.

The storage module 308 may include various facilities for storing data such as data store 124 as well as memory for storing the instructions for executing the one or more modules depicted in FIG. 3.

The test generator module 310 can generate automated tests to test the functionality of a target application 132. For example, in some embodiments, the test generator module 310 can generate one or more testing scenarios for testing an application. A testing scenario represents a plan to check the interactive functionality of the target application, for example, by filling forms, clicking buttons, viewing screen changes, and otherwise interacting with the various GUI elements of an application. A generated testing scenario plan may define a sequence of steps of interaction with the target application 132. As an illustrative example, a generated testing scenario may include 1) start the target application 132; 2) wait, 3) crawl the first page in the GUI of the target application 132 to identify one or more interactive elements, 4) interact with each of the identified interactive elements (e.g., click buttons, enter data into fields, etc.), and 5) create additional test scenario plans for every combination of interactive elements on the page, etc. In some embodiments, each step in the test scenario is defined as a data object (e.g., a JavaScript™ Object Notation (JSON) object).

In some embodiments, an automated test for a target application 132 can be configured based on inputs from a developer user 152 received via interface 153. For example, the developer user 152 can specify which types of elements to interact with as part of the test, how long a test executor 314 should wait for a reaction after interacting with an element, which areas of the target application 132 to prioritize for testing, etc. In some embodiments, automated tests can be generated based on one or more rules that specify certain sequences of interaction. A directory of rules may be stored in storage module 308. In some embodiments, the rules used to generate tests may be specific to any of an application, an application type (e.g., an Apple™ iOS app), an industry type (e.g., travel app), etc. As will be described in more detail, in some embodiments, automated tests can be generated based on the recorded interaction with the target application 132 by end users 140.

The test manager module 312 may manage various processes for performing an automated test. For example, the test manager may obtain a generated test scenario from storage module 308, identify tasks associated with the test scenario, assign the tasks to one or more test executors 314 to perform the automated test, and direct test results received from the test executors 314 to a test results generator for processing. In some embodiments, the test manager 312 may coordinate tasks to be performed by a single test executor 314. In other embodiments, the test manager 312 may coordinate multiple test executors (in some cases operating in parallel) to perform the automated test.

The test executor module 314 may execute the one or more tasks associated with an automated test of a target application 132. In an example embodiment, the test executor 314 first requests a next task via any type of interface between the test executor 314 and other components of the automated test platform 300. Such an interface may include, for example, one or more APIs. An entity (e.g., the test manager 312) may then obtain the next task in response to the test executor's 314 request and return the task to the test executor 314 via the interface. In response to receiving the task, the test executor 314 starts an emulator, walks through (i.e., crawls) the target application 132 (e.g., by identifying and interacting with a GUI element) and obtains a test result (e.g., screen capture of the GUI of the target application 132). The test executor 314 then sends the obtained result (e.g., the screen capture) via the interface to a storage device (e.g., associated with storage module 308). The test executor 314 can then repeat the process of getting a next task and returning results for the various pages in the GUI of the target application 132 until there are no additional pages left, at which point the test executor 313 may send a message indicating that the task is complete.

The test results generator 316 may receive results from the one or more test executors 314, process the results, and generate an output based on the results for presentation to the developer user 152, for example, via interface 153. As previously mentioned, the results returned by the test executor 314 may include screen captures of the GUI of the target application 132, for example, at each step in the automated test process. The test results generator 316 may process the received screen captures to, for example, organize the captures into logical flows that correspond with user interaction flows, add graphical augmentations to the screen captures such as highlights, etc. The test results generator 316 may further process results from repeated tests to detect issues such as broken GUI elements. For example, by comparing a screen capture from a first automated test to a screen capture from a second automated test, the test results generator may detect that a GUI element is broken or otherwise operating incorrectly.

The screenshot analyzer module 318 may process screenshots of a GUI of the target application 132 (e.g., the screenshots returned as results by a test executor) to detect or otherwise identify errors or other issues with the target application 132. Detected errors may include, for example, broken interactive elements, missing interactive elements, improperly displayed interactive elements, improperly configured interactive elements, etc. As will be described in more detail, in some embodiments, the screenshot analyzer may process the screenshots using one or more machine learning models to detect such errors.

Although depicted as a separate module in FIG. 3, in some embodiments, screenshot analyzer 318 may be part of any of the test executor 314 and/or test results generator 316. For example, in some embodiments, each test executor 314 may be configured to process screenshots of a GUI as they are captured as part of an automated test to detect errors or other issues with a target application 132.

Various components of automated testing platform 300 may apply machine learning techniques in their respective processes. For example, test generator module 310 may apply machine learning when generating a test scenario to apply to a target application 132. As another example, a test executor 314 may apply machine learning to identify elements in a GUI of the target application 132 and may apply machine learning to decide how to interact with such elements. As yet another example, the screenshot analyzer module 318 may apply machine learning to process screenshots of GUI of a target application 132 to detect errors or other issues with the target application 132.

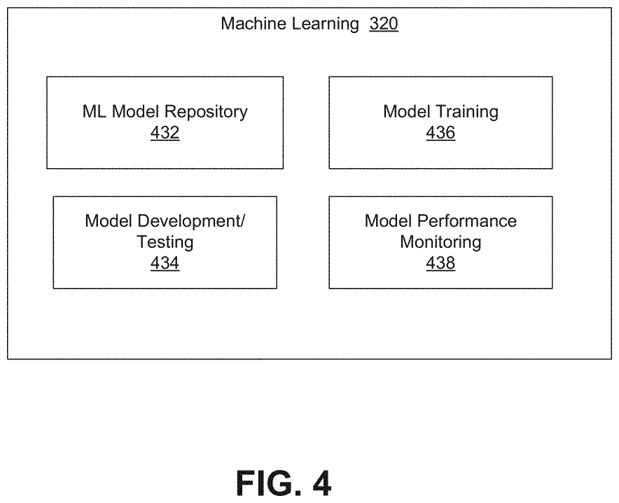

In any case, the machine learning module 320 may facilitate the generation, training, deployment, management and/or evaluation of one or more machine learning models that are applied by the various components of automated testing platform 300. FIG. 4 shows a block diagram of an example machine learning module 320 depicting various example subcomponents. As shown in FIG. 4, machine learning module 320 includes a model repository 432, a model development/testing module 434, a model training module 436, and a model performance monitoring module 438.

The model repository 432 may handle the storage of one or more machine learning models developed and deployed for use by automated testing platform 120. As will be described in greater detail, multiple different machine learning models may be configured to apply distinct processing logic to, for example, detect a particular type of error (e.g., missing interface features vs. broken interface features), process screenshots of a particular type of interface elements, process screenshots of a particular type of application, and/or process screenshots of a particular target application 132. In other words, the model repository 432 may store multiple machine learning models that can be selectively applied to, for example, process images of a target application GUI depending on the characteristics of the target application GUI.

The model development/testing module 434 may handle the configuration and/or testing of machine learning models prior to deployment, and the model training module 436 may handle the training of machine learning models prior to deployment. For example, an administrator user associated with platform 120 may access the model development/testing module 434 and/or model training module 436 to develop, train, and/or test one or more machine learning models prior to deployment. As a specific example, an administrator may use module 434 to set various hyperparameters of a model in development and then specify a set of training data using module 436 to perform training using the set hyperparameter values and specified training data. The training module 436 will perform the training of the model under development to generate a trained model which can be tested by the administrator user again using module 434.

The model performance monitoring module 438 may handle monitoring the performance of trained machine learning models after deployment. For example, the model performance monitoring module 438 may track outputs generated by deployed models and generate performance metrics indicative of a level of performance of the models (e.g., accuracy, latency, logarithmic loss, mean absolute error, mean squared error, confusion matrix, etc.). The performance metrics generated by the model performance monitoring module 438 may be accessed by an administrative user associated with platform 120 to monitor the performance of the various deployed models and make decisions regarding retraining and/or decommissioning models if they do not meet certain performance criteria. In some embodiments, the model performance monitoring module 438 may automatically cause the retraining and/or decommissioning of models in response to determining that such models do not meet certain performance criteria.

### Example Automated Testing Process

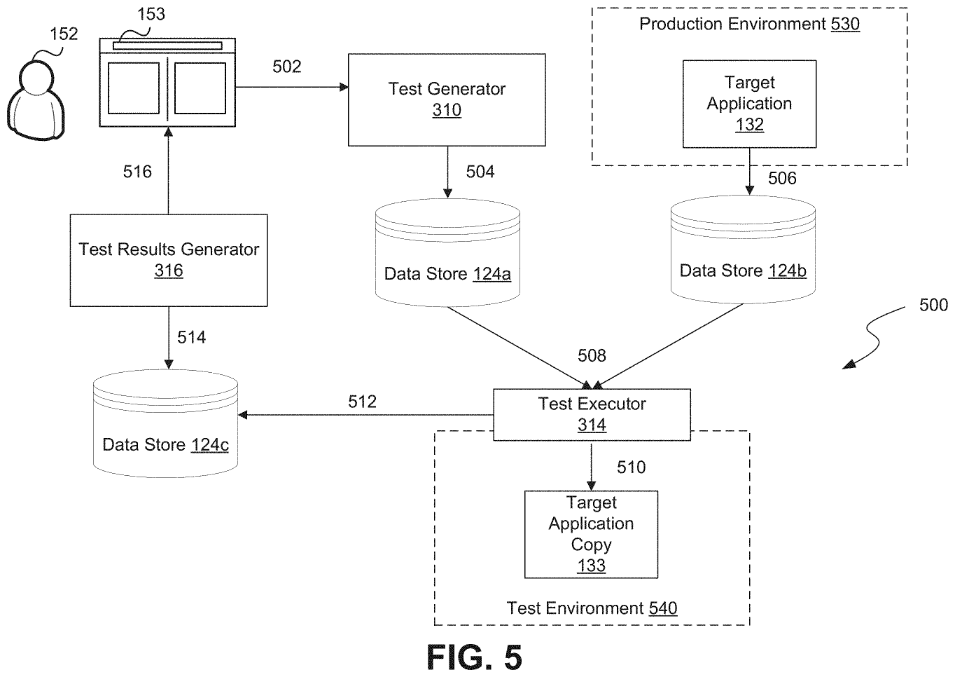

FIG. 5 is an architecture flow diagram that illustrates an example automated testing process 500. The example process 500 is described with reference to components of an automated testing platform 120, 220, 300 that are described with respect to FIGS. 1-3 (respectively).

Example process 500 begins at operation 502 with a developer user 152 providing inputs, via interface 153, to configure a new automated test of a target application 132. As depicted in FIG. 5, the target application 132 is deployed in a production environment 530 (e.g., hosted by an application server 130) and may be accessible by one or more end users 142. The production environment 430 may represent an environment where the target application 132 is available to the general public or may represent some sort of closed production environment that is only accessible to a select set of end users (e.g., Quality Assurance (QA) testers). In any case, the production environment 430 may include or otherwise mimic the conditions under which the target application 132 with be accessed by an intended set of end users.

The test generator 310 then uses the inputs provided at operation 502 to generate one or more testing scenarios for the target application 132, and at operation 504, the test generator 310 stores test data indicative of the generated testing scenarios in data store 124a. As previously discussed, each testing scenario may define a sequence of tasks with each task represented in a data object (e.g., a JSON object).

At operation 506, application files associated with target application 132 are uploaded from the production environment 530 and stored at data store 124b. The application files uploaded to data store 124b may comprise the entire target application and/or some portion thereof. For example, in the case of a website, the uploaded files may include one or more files in Hypertext Markup Language (HTML) that can then be tested using one or more different browser applications stored in the automated testing platform. In some embodiments, a test manger 312 (not shown in FIG. 5) coordinates the uploading of test files from the production environment 530.

At operation 508, a test executor 314 downloads data indicative of a stored testing scenario from data store 124a and the stored application files from data store 124b and at operation 510 initiates testing of a target application copy 133 in a separate test environment 540. The test environment 540 may be part of a virtual machine configured to mimic the computer system or systems hosting the production environment 530. Again, although not depicted in FIG. 5, in some embodiments, a test manager 312 may coordinate the initiation of the test environment 540 and the download of the application files into the test environment 540. In some embodiments, an emulator (e.g., browser emulator, operating system emulator, etc.) is initiated in the test environment 540 to facilitate automated testing of the target application 133.

In some embodiments, the process of testing by the test executor 314 may include obtaining a task from a test manager 312, walking through the application 133 (e.g., by identifying and interacting with GUI elements) and obtaining test results such as captured screenshots of the GUI of the application 133 before, during, and/or after interaction with the various GUI elements. The test results (e.g., screen captures) obtained by the test executor 314 can then be stored, at operation 512, in data store 124c. This process of storing test results at operation 512 may be performed continually as test results are obtained or at regular or irregular intervals until all the pages in the target application 133 have been tested or the defined task is otherwise complete.

Notably, in some embodiments, the obtained task may only specify a high-level task to be performed by the test executor 314 as opposed to specific instructions on how to perform the task. In such cases, a test executor may apply artificial intelligence techniques to perform a given task. For example, in response to receiving a task to enter a value in a search field, the test executor 314 may, using artificial intelligence processing, crawl the various GUI elements associated with a target application 132 to identify a particular GUI element that is likely to be associated with a search field. In some embodiments, this may include processing various characteristics associated with a GUI element (e.g., type of element (field, button, pull-down menu, etc.), location on a page, element identifier, user-visible label, etc.) using a machine learning model to determine what a particular GUI element is.

At operation 514, the test results generator 316 accesses the test results stored in data store 124c for further processing. For example, test results generator 316 may process accessed test results to, for example, organize screen captures into logical flows that correspond with user interaction flows, add graphical augmentations to the screen captures such as highlights, etc. The test results generator 316 may also access test results from a previous test of the target application 132 to compare the new test results to previous test results. For example, by comparing a screen capture from a first automated test to a screen capture from a second automated test, the test results generator 316 may detect that a GUI element associated with target application 132 is broken or otherwise operating incorrectly.

Finally, at operation 516, the test results generator may cause display of a set of processed test results to the developer user 152 via interface 153. Again, the processed test results may include screen captures of the GUI of the target application 132 that are organized into logical flows, indicators of GUI elements that are broken or otherwise operating incorrectly, etc.

The process depicted in FIG. 5 is an example provided for illustrative purposes and is not to be construed as limiting. Other processes may include more or fewer operations and/or may involve more or fewer components than are depicted in FIG. 5 while remaining within the scope of the present disclosure. For example, although depicted in FIG. 5 as separate entities, data stores 124a-c may be part of an overall system data store (e.g., data store 124 of FIG. 1) and/or may represent more than three separate data storage devices.

### Processing Screenshots Using Machine Learning Diagnostic Models

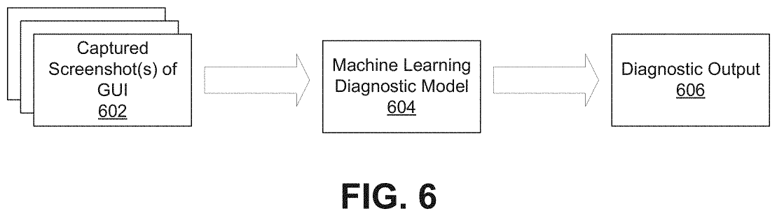

FIG. 6 shows a flow diagram of an example process for applying a machine learning diagnostic model 604 to process one or more captured screenshots 602 of a target application 132 GUI to generate a diagnostic output 606. The diagnostic model 604 is configured to apply algorithm(s) to an image (i.e., a captured screenshot of a GUI) to produce a diagnostic output 606 that conveys information about the presence or lack of presence of an error or other issue associated with the GUI of the target application 132. The algorithm(s) of a diagnostic model will generally perform several different processes via the use of tools such as artificial neural networks (ANN). These processes can include image processing, feature analysis, and data classification. Other types of tools applied can include, for example, Naïve Bayes classifiers, support vector machines, random forests, etc. The specific type of machine learning algorithm applied in any use case will depend on the requirements of the use case.

Once captured, a screenshot (or a sequence of screenshots) 602 of the GUI of the target application 132 can be processed by one or more machine learning diagnostic models 604 to generate the diagnostic output 606. The diagnostic output 606 by the diagnostic model 604 may include, for example, detected features, a diagnostic classification (e.g., error detected vs. no error detected), a reason for the classification (e.g., an analysis of detected features), as well as other information such as a confidence metric indicative of a level of confidence that the classification is accurate. In some embodiments, the diagnostic output may include visualizations that indicate detected features indicative of the classification. For example, a captured screenshot may be presented to a developer user 152, via interface 153, along with a visual augmentation that highlights a portion of the GUI that is associated with an error detected using the machine learning diagnostic model 604.

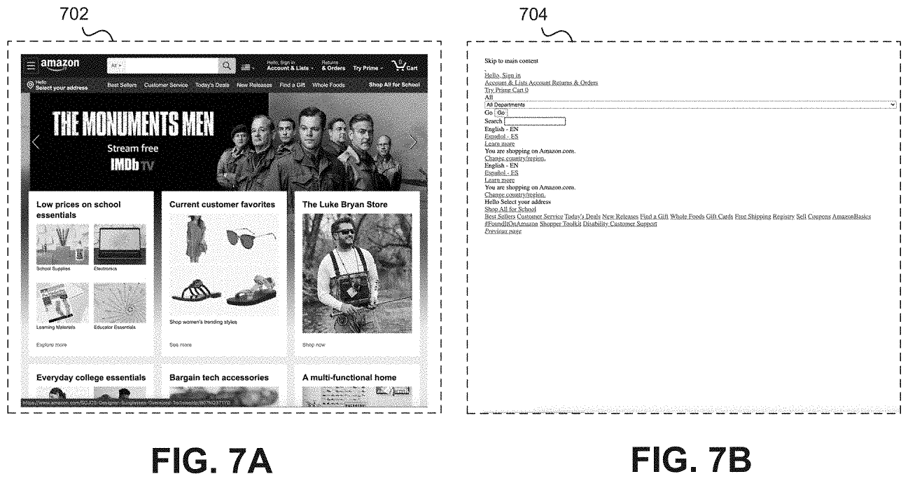

FIGS. 7A and 7B shows example screenshots 702a and 702b (respectively) of a target application GUI (specifically a web page) that illustrates how the visual presentation of the GUI can indicate errors or other issues in the target application. Specifically, FIG. 7A shows a screenshot 702 of a webpage that is operating normally and FIG. 7B shows a screenshot 704 of the exact same webpage in a different state. In this scenario, the screenshot 704 of the webpage in the different state appears different than screenshot 702 of the same webpage due to damaged Cascading Style Sheets (CSS) links. In an example embodiment, these captured screenshots 702 and 704 can be processed using a machine learning diagnostic model 604 to the issue in the CSS links. Further, the machine learning diagnostic model 604 can be trained (e.g., using labeled sets of screenshots for various known issues) to detect the specific type of issue present. For example, inputting screenshot 702 into the machine learning diagnostic model 604 may produce a first diagnostic output indicative that the target application is operating normally. Conversely, inputting screenshot 704 into the machine learning diagnostic model 604 may produce a first diagnostic output indicative that the target application is broken, and more specifically, that the CSS links are damaged.

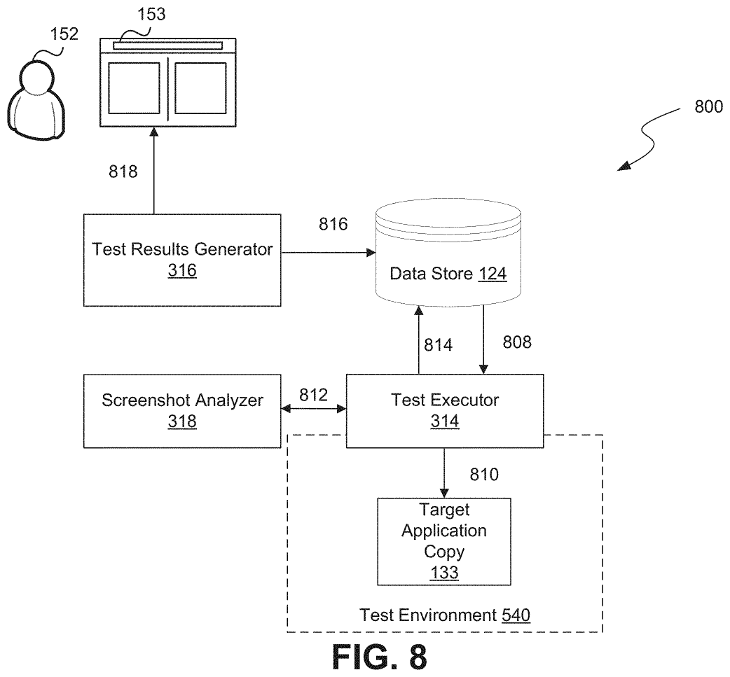

FIG. 8 shows an architecture flow diagram that illustrates an example automated testing process 800 that includes processing captured screenshots using one or more machine learning models. The example process 800 is described with reference to components of an automated testing platform 120, 220, 300 that are described with respect to FIGS. 1-3 (respectively).

Example process 800 begins at operation 808 with a test executor 314 downloading the application files from data store 124 and at operation 810 initiating testing of a target application 133 in test environment 540, for example, as described with respect to operation 508 in example process 500 of FIG. 5.

In some embodiments, the process of testing by the test executor 314 may include obtaining a task from a test manager 312, walking through the application 133 (e.g., by identifying and interacting with GUI elements) and obtaining test results such as captured screenshots of the GUI of the application 133 before, during, and/or after interaction with the various GUI elements.

At operation 812, the test executor 314 may access screenshot analyzer 318 to process any captured screenshots of the GUI of the target application 133 using one or more machine learning diagnostic models, for example, as described with respect to FIG. 6. In some embodiments, operation 812 may include sending an image (i.e., a screenshot) to screenshot analyzer 318 for processing and then receiving a diagnostic output based on the processing from the screenshot analyzer 318. As previously mentioned, the diagnostic output may include, for example, detected features, a diagnostic classification (e.g., error detected vs. no error detected), a reason for the classification (e.g., an analysis of detected features), as well as other information such as a confidence metric indicative of a level of confidence that the classification is accurate. In some embodiments, the diagnostic output resulting from the processing of a screenshot may be associated with the screenshot as a tag or some other type of metadata indicative of any of the detected features, a diagnostic classification, a reason for the classification, and/or a confidence metric. In some embodiments, the diagnostic output may include the processed screenshot along with one or more visual augmentations that are indicative of detected features and/or a classification. For example, the screenshot analyzer 318 may add a visual overlay to a region of a screenshot corresponding to a portion of the GUI of target application 133 with the detected error.

In some embodiments, the test executor 314 will send screenshots to the screenshot analyzer 318 for processing in real time or near real time (i.e., within seconds or fractions of a second) as each screenshot is captured. In other embodiments, the test executor 314 may collect a batch of screenshots and send the batch of screenshots to the screenshot analyzer 318 for processing. For example, the test executor may collect a sequence of screenshots depicting a sequence of states of a GUI of the target application 133 during a particular interaction flow and then send the sequence of screenshots to be processed together using the screenshot analyzer 318.

The diagnostic output of the processing by the screenshot analyzer 318 can then be added to the set of test results that are returned by the test executor 314 and at operation 814 are stored in data store 124, for example, as described with respect to operation 512 of process 500. This process of storing test results at operation 814 may be performed continually as test results are obtained or at regular or irregular intervals until all the pages in the target application 133 have been tested or the defined task is otherwise complete.

At operation 816, the test results generator 316 accesses the test results stored in data store 124 for further processing, for example, as described with respect to operation 514 in example process 500. As previously mentioned, the test results generator 316 may process accessed test results to, for example, organize screen captures into logical flows that correspond with user interaction flows, add graphical augmentations to the screen captures such as highlights, etc.

In example process 800, the test results generator 316 may access diagnostic outputs included in the stored test results (i.e., diagnostic outputs generated by screenshot analyzer 318 and stored by test executor 314) to generate the test results that will be displayed to the developer user 152. For example, the test results generator 316 may access a screenshot stored in data store 124, read a tag or other metadata indicative of a diagnostic output (e.g., a diagnostic classification) associated with the screenshot, and then generate a test result that includes an indication of the diagnostic output. The indication generated by test results generator 316 may include, for example, a visual element that indicates a diagnostic classification (e.g., error vs. no error). Similarly, the indication generated by test results generator 316 may include, for example, a visual overlay to a region of the screenshot corresponding to a portion of the GUI of target application 133 with the detected error.

In any case, at operation 818, the test results generator 316 may cause display of a set of processed test results to the developer user 152 via interface 153, for example, as described with respect to operation 516 of process 500.

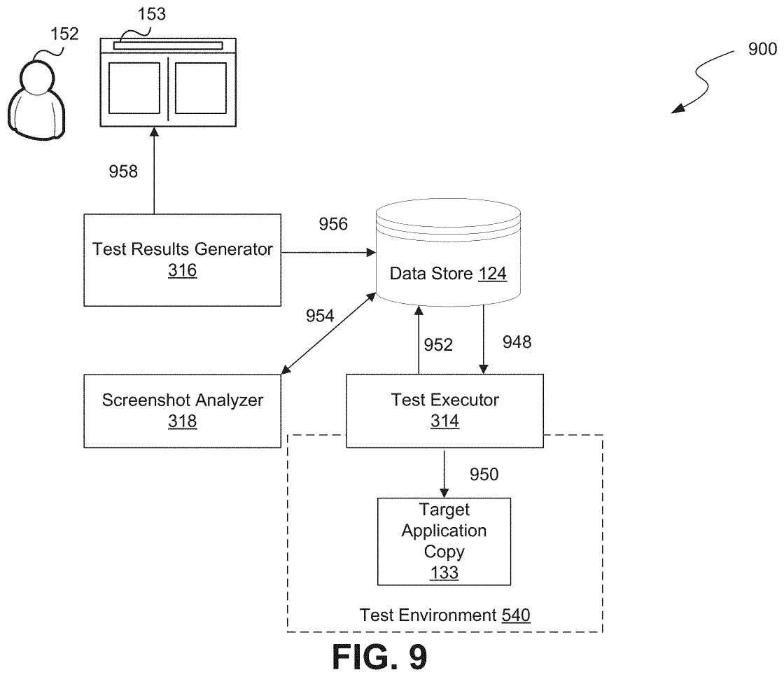

Process 800 depicted in FIG. 8 is an example provided for illustrative purposes and is not to be construed as limiting. Screenshots of a target application GUI may be processed differently in other embodiments. For example, in some embodiments, the one or more machine learning models used for processing screenshots may be integrated into the test executor 314 (as opposed to a separate module such as screen analyzer 318). In such embodiments, the test executor 314 may capture screenshots and process the captured screenshots using one or more machine learning diagnostic models as part of the automated testing process performed at operation 810. In some embodiments, the test executor 314 may capture and store screenshots at data store 124 for later processing by another component such as screenshot analyzer 318, for example, as depicted in FIG. 9.

FIG. 9 shows an architecture flow diagram that illustrates an example alternative automated testing process 900 that includes processing captured screenshots using one or more machine learning models. As with example process 800, the example process 900 is described with reference to components of an automated testing platform 120, 220, 300 that are described with respect to FIGS. 1-3 (respectively). Example process 900 is similar to example process 800 except that the included screenshot analyzer 318 operates independently from the test executor 314.

Example process 900 begins at operation 948 with the test executor 314 downloading the application files from data store 124, at operation 950 with initiating testing of a target application 133 in the test environment 540, and at operation 952 with storing test results (e.g., captured screenshots) in data store 124.

The screenshots stored in data store 124 can then be accessed separately by a screenshot analyzer 318 at operation 954 for processing. For example, at operation 954, the screenshot analyzer 318 may access one or more screenshots stored in data store 124, process the accessed screenshots using one or more machine learning diagnostic models, and generate diagnostic outputs based on the processing. The diagnostic outputs generated by screenshot analyzer 318 may also be stored in data store 124 as tags or other metadata associated with the corresponding screenshots or as separate data.

In some embodiments, operation 954 may be performed by the screenshot analyzer after the test executor has completed crawling the target application 133 and obtaining screenshots. In such embodiments, the screenshot analyzer 318 may access a batch of multiple screenshots (e.g., corresponding to a particular user interaction flow) and process the batch of screenshots together using the one or more machine learning diagnostic models.

In some embodiments, the screenshot analyzer 318 may be triggered by the test results generator 316 to process screenshots using one or more machine learning diagnostic models. For example, at operation 956, the test results generator 316 may access the test results stored in data store 124 for further processing, for example, as described with respect to operation 514 of process 500. As part of operation 956, the test results generator 316 may cause the screenshot analyzer 318 to process one or more of the screenshots included in the test results using one or more machine learning diagnostic models.

The process depicted in FIGS. 8-9 are examples provided for illustrative purposes and is not to be construed as limiting. Other processes may include more or fewer operations and/or may involve more or fewer components than are depicted in FIGS. 9-9 while remaining within the scope of the present disclosure. For example, although depicted in FIGS. 8-9 as a single data store 124, other embodiments may implement multiple different data stores. For example, in some embodiments, data store 124 may be implemented as multiple data stored 124a-c, as depicted in FIG. 5, for storing test data indicative of the generated testing scenarios, application files, and test results (respectively).

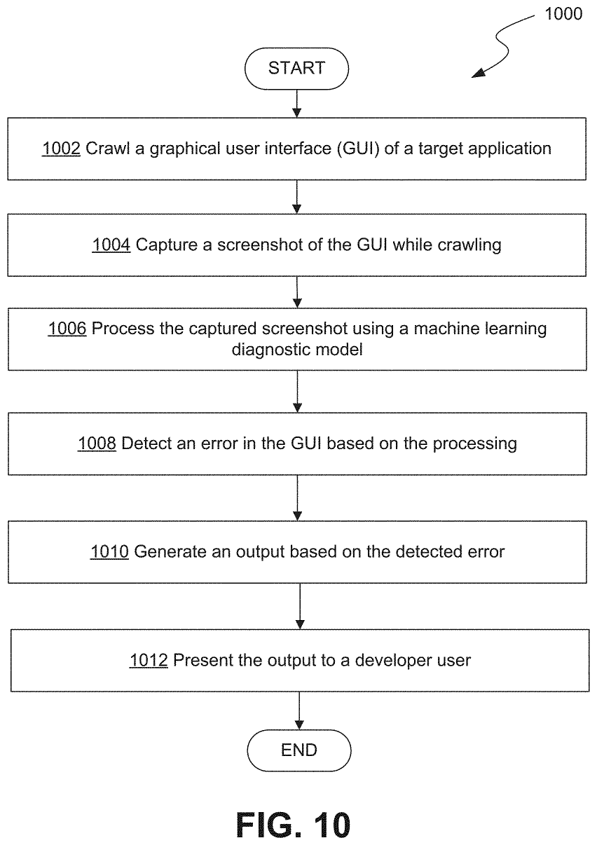

FIG. 10 shows a flow diagram of an example process 1000 for using a machine learning diagnostic model to detect errors or other issues in a GUI of a target application 132. Example process 1000 can be executed by one or more of the components of an automated testing platform 120. In some embodiments, the example process 1000 depicted in FIG. 10 may be represented in instructions stored in memory that are then executed by a processor. The process 1000 described with respect to FIG. 10 is an example provided for illustrative purposes and is not to be construed as limiting. Other processes may include more or fewer operations than depicted, while remaining within the scope of the present disclosure. Further, the operations depicted in example process 1000 may be performed in a different order than is shown.

Example process 1000 begins at operation 1002 with crawling a GUI of a target application 132, for example, as part of an automated testing process as previously described. As previously discussed, a test executor 314 may crawl a GUI of a target application 132 in response to tasks received from a test manager 312. In some embodiments, crawling the GUI of the target application 132 may include detecting and interacting with one or more interactive elements in the GUI according to an automated testing scenario. The one or more interactive elements may include, for example, buttons, pull-down menus, editable text fields, etc. Interacting with the interactive elements may therefore include, for example, pressing a button, scrolling through a pull-down menu and selecting an item in the pull-down menu, entering data in the editable text field, etc.

Example process 1000 continues at operation 1004 with capturing one or more screenshots of the GUI while crawling the GUI. For example, a test executor 314 may obtain test results when performing an automated test that include one or more screenshots of a GUI of a target application 132. In some embodiments, the screenshot captured at operation 1004 may be one of multiple screenshots captured during a sequence of interactions with one or more interactive elements of the GUI. For example, for a user flow involving entering data into an editable text field and pressing a button, the test executor may capture a first screenshot before entering any data, a second screenshot after entering data into the editable text field but before pressing the button, and a third screenshot after pressing the button. This is just an example to illustrate how multiple screenshots may be captured as part of a sequence of interaction with a GUI of a target application 132. Other sequences may be more complicated and may involve more screenshots captured in sequence.

Example process 1000 continues at operation 1006 with processing the screenshot of the GUI using a machine learning diagnostic model. As previously discussed, a machine learning diagnostic model may apply one or more algorithms configured to produce a diagnostic output (e.g., a classification decision) based on an input image (i.e., the screenshot captured at operation 1004). In some embodiments, the machine learning diagnostic model is an ANN that is trained to detect errors or other issues in a GUI based on captured screenshots of the GUI.

In some embodiments, the machine learning diagnostic model applied at operation 1006 is one of multiple different machine learning diagnostic models stored in a model repository in data store 124. For example, the machine learning diagnostic model applied at operation 1006 may include distinct processing logic to detect a particular type of error such as broken CSS links. In such an embodiment, one or more of the multiple machine learning diagnostic models stored in the model repository may include distinct processing logic for detecting a different one of multiple different types of errors. The multiple different types of errors may include, for example, an interactive element that is broken, an interactive element that is missing from the GUI, an interactive element that is in an incorrect location on a page in the GUI, etc. Therefore, in order to detect multiple different types of errors, operation 1006 may include processing the screenshot using multiple different machine learning diagnostic models where each of the multiple different machine learning diagnostic models includes distinct processing logic to detect a different one of the multiple different types of errors.

In some embodiments, machine learning diagnostic models may be configured for detecting errors in specific applications and/or application types. In such embodiments, the machine learning diagnostic model can be trained to detect errors in the particular target application by using training images (e.g., screenshots) obtained from that particular target application. In some embodiments, the machine learning diagnostic model may be configured to detect errors in a particular type of application (e.g., webpage, web app, iOS™ app, Android™ app, etc.). In such embodiments, the machine learning diagnostic model can be trained to detect errors in the particular type of application by using training images (e.g., screenshots) obtained from multiple different applications of that application type. In some embodiments, machine learning diagnostic models may be configured for detecting errors in applications of a particular functionality (e.g., travel application, social media application, music player application, camera application, etc.). In such embodiments, the machine learning diagnostic model can be trained to detect errors in the particular type of application functionality by using training images (e.g., screenshots) obtained from multiple different applications of that type of functionality.

Although not depicted in the flow diagram of FIG. 10, in some embodiments, example process 1000 may additionally include selecting a machine learning diagnostic model from the model repository before processing the screenshot at operation 1006. For example, process 800 may include selecting a machine learning diagnostic model that satisfies a similarity criterion when compared to the target application. In other words, a machine learning diagnostic model is selected that is appropriate for the target application. The similarity criterion may be based on application operating system (e.g., iOS™ vs. Android™), application functionality (e.g., travel application vs. music playback application), etc. If a machine learning diagnostic model is specifically configured for the target application, that model would most closely satisfy the similarity criterion.

As previously mentioned, the screenshot captured at operation 1004 may be one of multiple different screenshots, for example, captured during a sequence of interaction with one or more interactive elements of the GUI of the target application. In such embodiments, operation 1006 may include processing all of the multiple screenshots together using a machine learning diagnostic model. For example, multiple screenshots may be input simultaneously (or in close succession) to a machine learning diagnostic model that includes processing logic for detecting an error in a GUI based on sequences of screenshots of the GUI.

Example process 1000 continues at operation 1008 with detecting an error or other issue associated with the GUI based on the processing performed at operation 1006. As previously discussed, the diagnostic output of a machine learning diagnostic model can include, for example, detected features, a diagnostic classification (e.g., error detected vs. no error detected), a reason for the classification (e.g., an analysis of detected features), as well as other information such as a confidence metric indicative of a level of confidence that the classification is accurate. In the case of a diagnostic output that includes a classification decision, operation 1008 may include reading the classification decision and detecting the error if the classification decision indicates an error is present. In some embodiments, this classification decision can be conditioned based on an associated confidence metric. For example, if the confidence metric associated with a classification decision of a detected error is below a threshold confidence level, operation 1008 may include not detecting the error. In such cases, a confidence metric below a threshold confidence level may trigger reprocessing of the screenshot with the machine learning diagnostic model (i.e., performing operation 1006 again) and/or selecting an alternative model from the model repository for processing.

In some embodiments, the diagnostic output may be in the form of an error score indicative of a probability that an error is represented in a given screenshot. For example, the error score may be in the form of a numerical value on a scale from 0.0 to 1.0. In such an example, an error score of 0.0 may indicate lowest probability of an error being present and an error score of 1.0 may indicate a highest probability of an error being present. Accordingly, operation 808 may include determining whether an error score output by the machine learning diagnostic model satisfies a specified scoring criterion (e.g., a threshold error score such as 0.7) and detecting the error if the error score satisfies the specified scoring criterion. The scoring criterion applied may be user-specified (e.g., by an administrator of the platform 120 and/or the developer user 152).

Example process 1000 continues at operation 1010 with generating an output based on the error detected at operation 1008. In some embodiments, the output generated at operation 1010 may include a visual output indicative of the detected error. For example, the visual output may include the screenshot along with a visual augmentation (e.g., an overlay) in a region of the screenshot corresponding to a portion of the GUI of the target application with the detected error. For example, if the error is a broken button in the GUI (e.g., inoperable, functioning incorrectly, mislabeled, etc.), the visual output may include a screenshot of a page of the GUI that includes the button along with a visual augmentation such as a highlighted or otherwise emphasized border around the button, an arrow pointing to the button, etc. In some embodiments, the output may include information about the detected error such as a description of the error, an identifier associated with the interactive element causing the error, recommended solutions to fix the error, a link to the actual page in the target application that includes the error, etc.

Example process 1000 concludes at operation 1012 with presenting the output generated at operation 1010 to a developer user 152, for example, via interface 153.

### Training Machine Learning Diagnostic Models

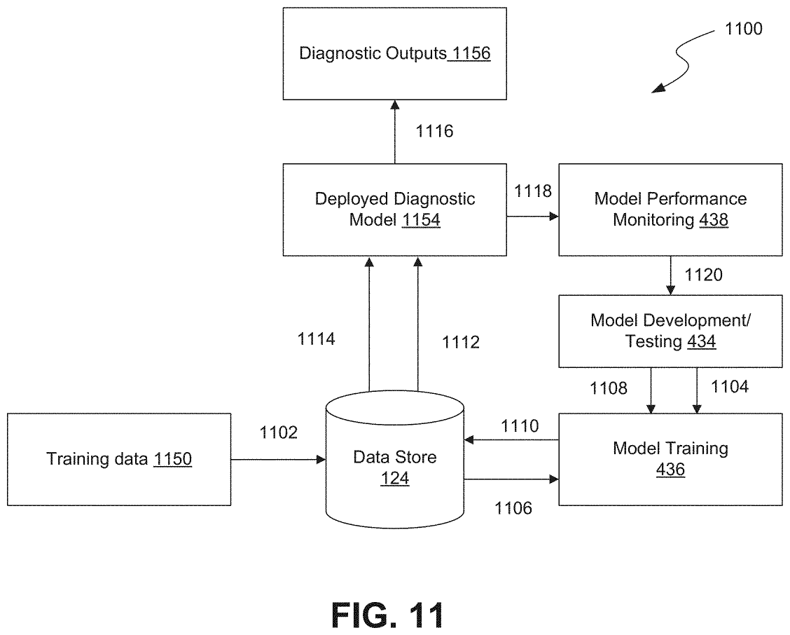

The diagnostic models used to detect errors in a target application may implement machine learning techniques. FIG. 11 depicts an architecture flow diagram of an example process 1100 for training and deploying such machine learning diagnostic models. Certain operations of the example process 1100 are described with respect to the components of the example machine learning module 320 described with respect to FIG. 4.

Example process 1100 begins at operation 1102 with storing training data 1150 in a data store 124 associated with the automated testing platform 120. The training data 1150 in this context can include images such as screenshots of application GUIs gathered on previous automated tests, feedback data, and/or any other data that can be utilized to train a machine learning diagnostic model. In the case of an application-specific model, the training data 1150 may include screenshots of that application captured during previous automated tests of the application. In the case of an application type-specific mode, the training data 1150 may include screenshots from multiple different applications of the specific application type (i.e., webpage, iOS™ application, Android™ application, etc.).

In some embodiments, the training data 1150 may be labeled with truth information to assist in the model training process. For example, screenshots of GUIs with errors (e.g., broken elements, misplaced elements, missing elements, etc.) may be labeled accordingly to indicate such errors whereas screenshots from fully functional GUIs may also be labeled accordingly to indicate the lack of errors. In some embodiments, the screenshots may be labeled automatically by platform 120 based on specified rules and/or results of previously performed automated tests. In some embodiments, screenshots may be labeled by human users such as experts in the particular application and/or application type.

At operation 1104, a machine learning diagnostic model is configured by a user that is associated with the automated testing platform 120. For example, an administrator user with specialized expertise in machine learning (e.g., a data scientist) may, using model development/testing module 434, configure a machine learning diagnostic model prior to training. Configuring the model prior to training may include, for example, formulating a problem to be solved (e.g., detecting a particular type of error), reviewing the training data, selecting an appropriate machine learning algorithm to use (e.g., an ANN), and/or setting one or more hyperparameter values for the model (e.g., a number of layers in the ANN). In some embodiments, the administrative user can configure the machine learning diagnostic model prior to training by selecting one or more options or setting one or more hyperparameter values that are communicated to the model training module 436.

At operation 1106, the configured machine learning diagnostic model is trained using at least some of the training data 1150 stored at data store 124. In some embodiments, operation 1106 may include the model training module 436 accessing at least some of the training data 1150 stored at data store 124 and processing the accessed training data 1150 using hyperparameter values and/or other settings associated with the model configured at operation 1104. In the case of an ANN, hyperparameters may include a quantity of layers and/or units (i.e., neurons) in the neural network, a dropout rate, learning rate, number of iterations, etc.

The model training process may utilize desired outputs included in the training data (e.g., truth labels) to learn and set various model parameters. In the case of an ANN, these parameters may include, for example, connections between neurons, weights of the connections, and biases in the neurons.

Once trained, the machine learning diagnostic model can be tested at operation 1108 prior to deployment. For example, an administrator user associated with platform 120 may, using development and/or testing module 434, cause the model training module 436 to run one or more tests on the trained model, for example, by processing data accessed from data store 124 using the trained machine learning diagnostic model. In most cases, the model training module 436 will use data other than the training data 1150 to test the trained machine learning diagnostic model.

Although not depicted as such in FIG. 11, the model configuration, training, and testing may be an interactive process that is performed several times before a machine learning diagnostic model is developed that is suitable for deployment. For example, as part of model testing at operation 1108, an administrator user may review results of the testing and decide to reconfigure the model, for example, by adjusting one or more hyperparameter values. This process is generally referred to as hyperparameter tuning.

Once the testing is complete, the trained machine learning diagnostic model can be deployed for use in error detection process. For example, at operation 1110, the trained machine learning diagnostic model can be stored in data store 124 (e.g., as part of a model repository) where it can be accessed, at operation 1112, for use by an online execution process. For example, the screenshot analyzer module 318 may, at operation 1112, access the trained model from the model repository at data store 124. The model accessed at operation 1112 is depicted in FIG. 11 as deployed model 1154. As previously discussed, the trained model may be stored as part of a library or registry that includes multiple machine learning models.

At operation 1114, screenshots captured, for example, as part of an automated test of a target application are accessed from data store 124 and processed using the deployed machine diagnostic model 1154 to, at operation 1116, generate one or more diagnostic outputs 1156, such as a diagnostics classification. For example, the screenshot analyzer module 318 may access screenshots at operation 1114, process the screenshots using the deployed machine learning model 1154, and generate a diagnostic output 1156 at operation 1116. The generated diagnostic outputs 1156 can then be utilized to inform other components of platform 120 such as test generator 310.

In some embodiments, the performance of the deployed machine learning model 1154 is monitored at operation 1118. For example, a performance monitoring module 438 may analyze outputs of the deployed machine learning model 1154 and generate performance metric values based on the analysis. Performance metrics can include, for example, accuracy, latency, confidence, confusion matrices, sensitivity, specificity, error, etc.

In some embodiments, the results of post-deployment model performance monitoring can be used at operation 1120 to guide development and/or testing of new machine learning diagnostic models. For example, in some embodiments, an administrator user associated with model development and/or testing may, using model performance monitoring module 438, review performance metrics of the deployed model 1154 and utilize this information to configure and/or tune new models for training. In some embodiments, a model performance monitoring by module 438 may automatically trigger a model retraining process, for example, in response to detecting a performance metric of the deployed model 1154 falling below a threshold value.

### Example Graphical User Interface

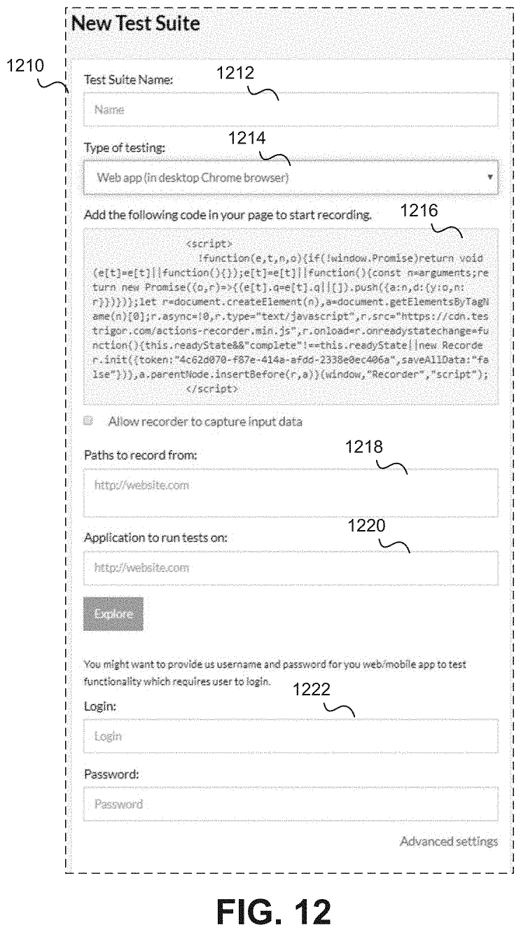

FIGS. 12-20 show a series of screens associated with an example developer GUI associated with automated testing platform 120. In other words, the example developer GUI depicted in FIGS. 12-20 may correspond with the interface 153 described with respect to FIG. 1 and may be utilized by a developer user 152 to perform automated testing of a target application 132. Accordingly, the developer GUI depicted in FIGS. 12-20 may be presented via a display associated with a developer user computing device 150. Note that the included screen captures depicted in FIGS. 12-20 are provided for illustrative purposes to show certain example features of a developer GUI associated with automated testing platform 120 and are not intended to be limiting. Some embodiments may include fewer or more user interaction features than are described with respect to FIGS. 12-20 while remaining within the scope of the introduced technique.

FIG. 12 shows an example screen 1210 of the example developer GUI that may be presented to a developer user 152 when setting up a new automated test. For example, in response to logging in to, or otherwise accessing, automated testing platform 120, a developer user 152 is presented with screen 1210 which includes a prompt to add a new application for testing. The example prompt depicted in screen 1210 includes an editable field 1212 to input a test name and an interactive element 1214 through which a developer user 152 can specify the type of application to be tested. For example, the interactive element 1214 is depicted in FIG. 12 in the form of a pull-down menu that allows the developer user 152 to select from multiple defined application types such as a website (in a desktop version of the Chrome™ browser), a website (in an Android™ version of the Chrome™ browser), an Android™ application, and an Apple™ iOS application. These are just example application types shown for illustrative purposes. Other application types may similarly be included in the prompt associated with screen 1210.

Example screen 1210 also includes a text-based script 1216 that the developer user can copy and place into the code of their application (e.g., website) to facilitate recording user interaction with the application. In some embodiments, such as script is provided when the developer user 152 selects, via element 1214, a website as the application type. Other mechanisms for facilitating recording user interaction may be provided for other application types. For example, if the developer user 152 selects an iOS application as the application type a different type of mechanism such as a link to download a recorder library may be provided to facilitate recording user interactions.

Example screen 1210 also include interactive elements through which a user can specify the paths from which to record user interactions and the application to be tested. For example, interactive element 1218 is an editable text field through which the developer user 152 can input a uniform resource locator (URL) associated with a website to specify a path from which to record user interaction data. Similarly, interactive element 1220 is an editable text field through which the developer user 152 can input a URL of the website to be tests. In the example depicted in FIG. 12, both URLs are the same; however, this may not be the case in all scenarios. Further, if the application is not a website (e.g., an iOS application) elements 1218 and/or 1220 may be replaced with a different UI element that enables the developer user 152 to upload a copy of the application, input a link to download the application, or otherwise enable access to the application.

In some cases, the target application 132 may be associated with some type of login or other authentication protection. In such cases, the developer GUI may prompt the developer user 152 to input necessary authentication information such as HTTP authentication login and password, application login and password, etc. For example, element 1222 in screen 1210 prompts the developer user 152 to input login and password information for the website.

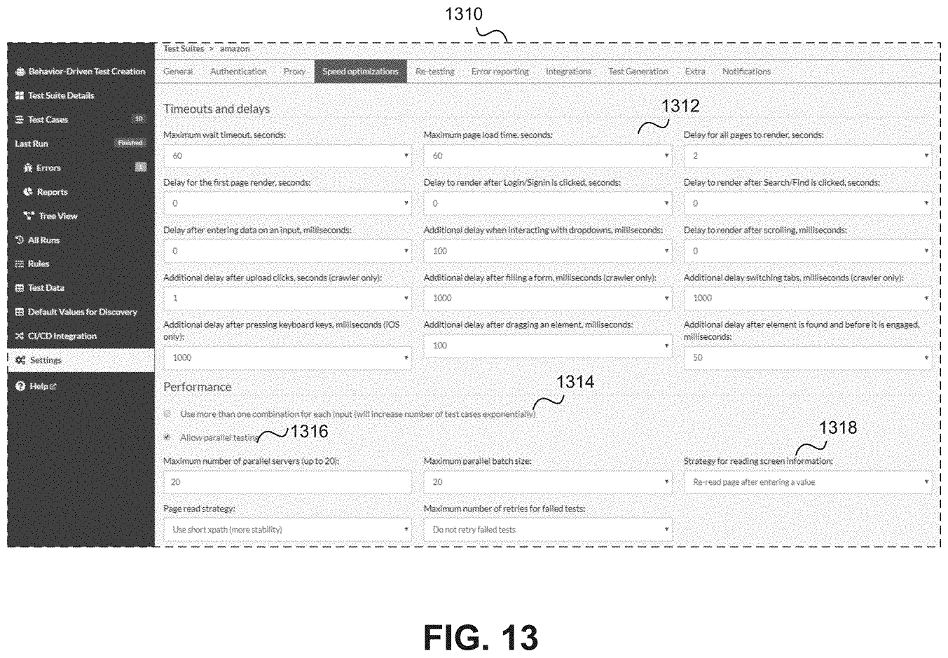

In some embodiments, the developer GUI may present options to the developer user 152 to specifically configure various characteristics of an automated testing process. FIG. 13 shows an example screen for configuring an automated test. Specifically, FIG. 13 shows a screen 1310 of an example developer GUI that includes various interactive elements through which a developer user 152 can set parameters to optimize the speed of performing an automated test. For example, screen 1301 includes various interactive elements 1312 (e.g., in the form of pull-down menus) through which a developer user 152 can set values for various latency-related parameters such as maximum wait timeout, maximum page load time, and delay for page to render. Maximum wait timeout specifies how long the automated testing platform 120 will wait for a server to respond to a page request. Lower numbers will result in a faster test, but larger numbers will be more tolerant of a slow network and/or a busy server. Maximum page load time specifies how long the automated testing platform 120 will wait for a server to send a requested page. Again, lower numbers will result in a faster test, but larger numbers will be more tolerant of a slow network and/or a busy server. Delay for page to render specifies how long the automated testing platform 120 will wait for a given page to render. Lower numbers will result in a faster test, but larger numbers will be more tolerant of larger, more complex pages or pages that are rendered by JavaScript™ in the browser. These are just example latency-related parameters and as depicted in FIG. 13, the screen may include options to set values for other latency related parameters.

Screen 1310 also includes interactive elements through which a developer user 152 can specify how thoroughly the target application is explored during automated testing. For example, by selecting element 1314 (depicted as a toggle button), the developer user 152 can instruct the automated testing platform 120 to perform a more thorough automated test that involves performing more than one testing scenario for each input. As noted, this will tend to increase the number of testing scenarios exponentially, which will result in a more thorough test of the interactive features of the target application 132 although such a test will be slower and more computationally expensive. Other interactive elements may prompt the developer user 152 to, for example, enable the use of parallel testing of scenarios (button 1316) to reduce the time needed to complete testing. Other interactive elements may prompt the developer user 152 to, for example, specify a strategy for reading screen information (pull-down menu 1318). For example, pull-down menu 1318 is depicted as set to re-read a page after entering a value. This setting may slow down testing, but may catch issues that would otherwise be missed if a given page is not re-read after inputting a value. These are just some example configurable parameters that can be set by the developer user via the GUI to configure and automated test based on recorded user interaction with a target application.

Once the developer user 152 has finished configuring the various parameters associated with the automated testing process, an automated test is generated and performed on the target application 132. For example, as part of the automated testing process, one or more test executors 314 will crawl the target application 132 to discover and interact with various interactive elements (e.g., clicking buttons, clicking links, clicking pull-down menus, filling out forms, etc.) and will obtain results (e.g., screen captures) based on the testing.

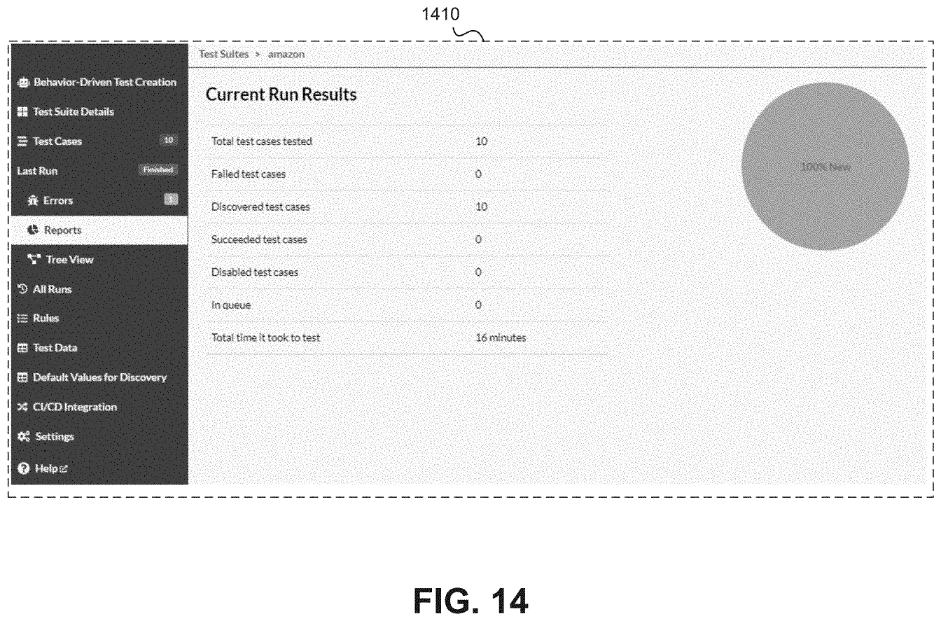

In some embodiments, once the automated test is complete, a summary of the automated test is provided, for example, as depicted in screen 1410 of FIG. 14. As shown in FIG. 14, the summary of an example automated test may provide various aggregate test result data such as total number of test scenarios performed, total number of failed test scenarios, total number of discovered test scenarios, total number of unchanged test scenarios (e.g., between different versions of the target application 132), total number of disabled test scenarios, total number of test scenarios to be retested, and total time to perform the overall automated test. These are just some illustrative examples of the type of information that can be provided in a test summary. Other types of information can similarly be presented while remaining within the scope of the introduced technique.

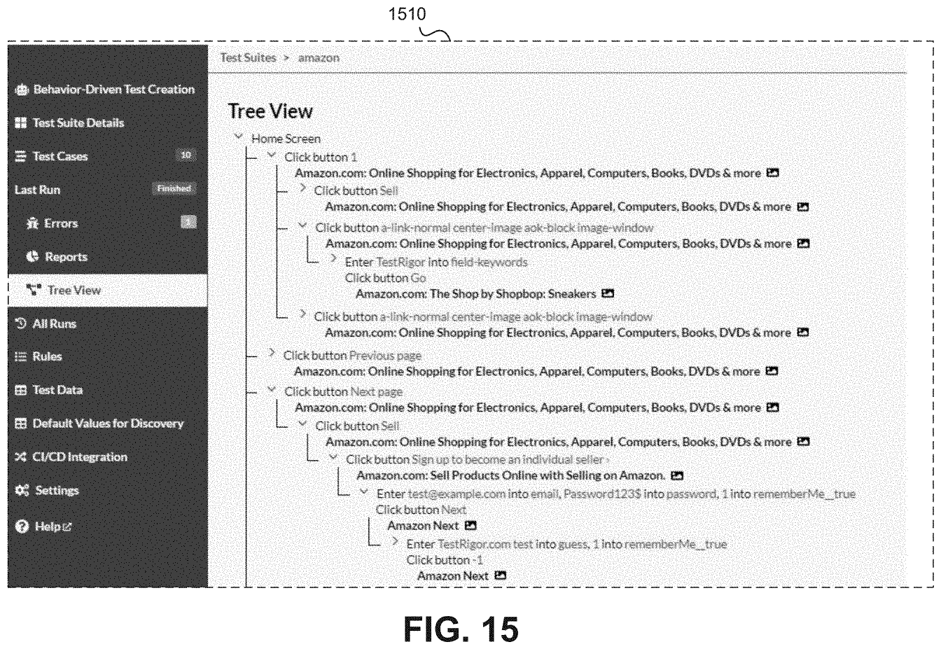

In some embodiments, tree view summary of the automated test can be displayed in the GUI. FIG. 15 shows a screen 1510 of an example developer GUI that includes a tree view summary of the various steps performed as part of an automated test. As shown in screen 1510, various steps performed by a test executor are listed (e.g., click button, enter value, etc.). The various steps are arranged as tree diagram based on branching interaction paths. For example, in the scenario depicted in screen 1510, each interaction path starts at a home screen of the target website and proceeds along different branches from that home screen. In some embodiments, the developer user can interact with the tree view summary to collapse and/or expand certain branches to facilitate navigation of the diagram.

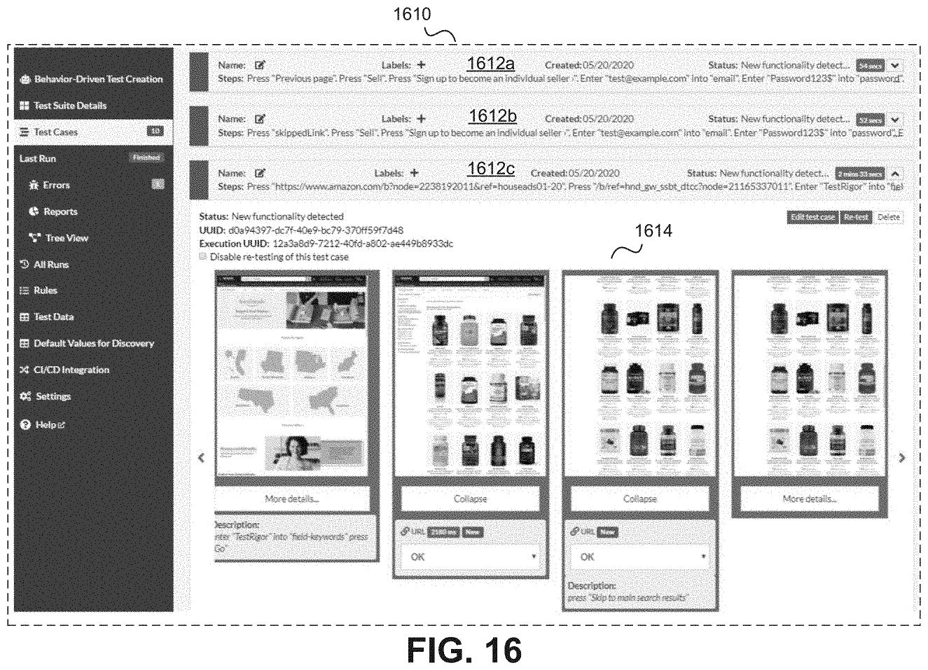

In some embodiments, results of the automated test are presented in the developer GUI. FIG. 16 shows a screen 1610 of an example developer GUI that includes results from various test scenarios performed as part of an automated test of a target application (in this example a website). As shown in FIG. 16, screen 1610 includes interactive elements 1612a-c corresponding to various test scenarios performed as part of an automated test of a target website. The interactive elements 1612a-c include information regarding the corresponding test scenario such as a name of the test scenario, the steps involved in the test scenario (e.g., press button, enter value, etc.), a date the test scenario was created, a status of the test scenario, and duration of the test scenario.

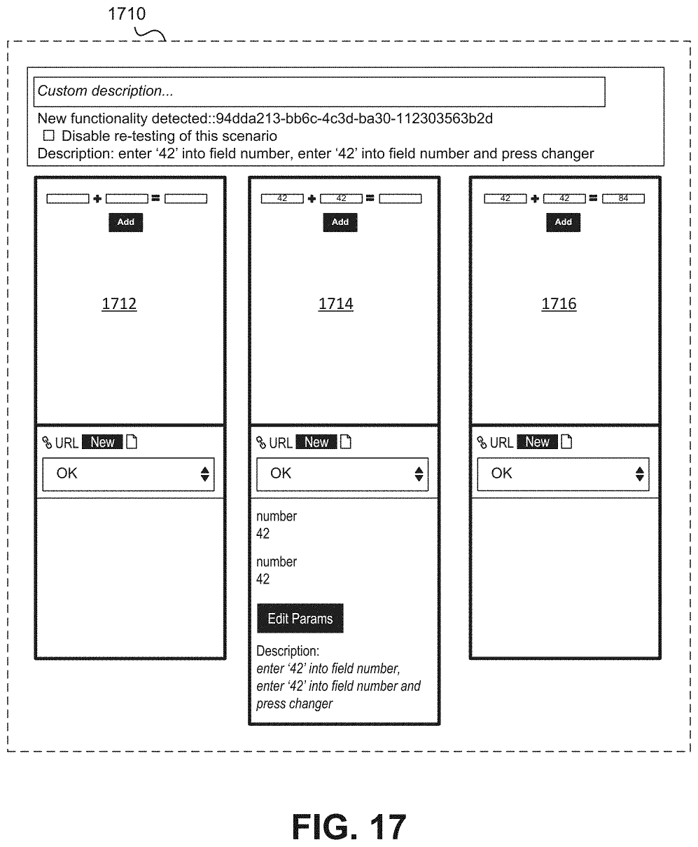

The interactive elements 1612a-c can be expanded to display results associated with each test scenario. For example, in response to detecting a user interaction, interactive element 1612c may dynamically expand to display results of the test scenario in the form of screen captures 1614 of the target application taken by the test executor during the various steps associated with the test scenario, as depicted in FIG. 16. Additional details on how test results can be presented in a developer GUI are described with respect to FIGS. 17-20.

FIG. 17 shows a screen 1710 of an example developer GUI that includes a sequence of screen captures depicting an example test scenario performed during the automated test of a target application 132 (in this case a calculator app). The sequence of screen captures depicted in screen 1710 may be similar to the sequence of screen captures 1614 depicted in screen 1610. Specifically, screen 1710 depicts a sequence of screenshots of the target application 132 during a test of a specific functionality an end user 142 may take while interacting with the target application 132. In this case, the interaction is entering a number into an editable field and pressing an “add” button. Screen capture 1712 shows the GUI of the target application 132 in a first state prior to entering the number, screen capture 1714 shows the GUI of the target application 132 in a second state after entering the number (“42”) but prior to pressing the “add” button, and screen capture 1716 shows the GUI of the target application 132 in a third state after pressing the “add” button. The example test scenario illustrated in the sequence of screen captures shown in FIG. 17 is relatively simple and is provided for illustrative purposes. An actual application may have many possible test scenarios involving more complicated sequences of interaction.

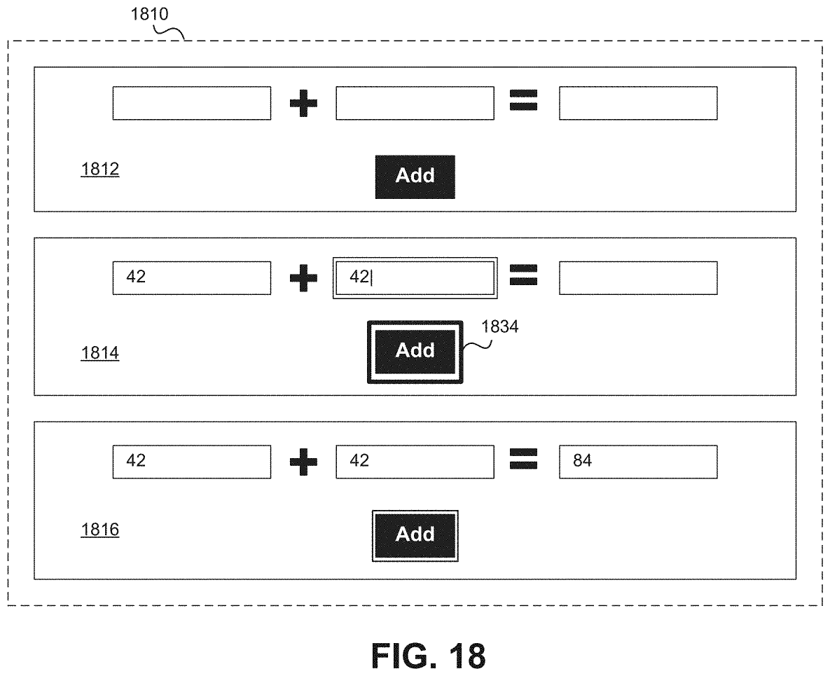

In some embodiments, the developer GUI may enable the developer user 152 to zoom in on the screen captures to view how the GUI of the target application 132 responded to various interactions. FIG. 18 shows an example screen 1810 of the developer GUI that shows a zoomed in portion of each of the respective screen captures 1712, 1714, and 1716 of FIG. 17. Specifically, screen capture 1812 shows a zoomed in portion of screen capture 1712 depicting the GUI of the target application 132 in the first state (i.e., before any interaction). Screen capture 1814 shows a zoomed in portion of screen capture 1714 depicting the GUI of the target application 132 in the second state (i.e., after entering the number 42 but before pressing the “add” button). Screen capture 1816 shows a zoomed in portion of screen capture 1716 depicting the GUI of the target application 132 in the third state (i.e., after pressing the “add” button).

In some embodiments, the screen captures displayed via the developer GUI may include visual augmentations that provide additional information to the developer user 152 reviewing the results. For example, as shown in FIG. 18, a visual augmentation 1834 is added to indicate the interaction leading to the next screen capture. Specifically, the visual augmentation 1834 includes a highlight that surrounds a region of the GUI of the target application 132 corresponding to the “add” button. This visual augmentation 1834 indicates to the developer user 152 that the “add” button is pressed resulting in the next screen capture 1816. This is just an example of a visual augmentation that can be added to screen captures to provide additional contextual information. Other types of visual augmentation can similarly be implemented. In some embodiments, the added visual augmentation can be color coded to indicate different types of interaction (e.g., button press vs. data entry). In some embodiments, visual augmentations may be animated to indicate different types of interaction (e.g., a gradually widening highlight indicating a button press).

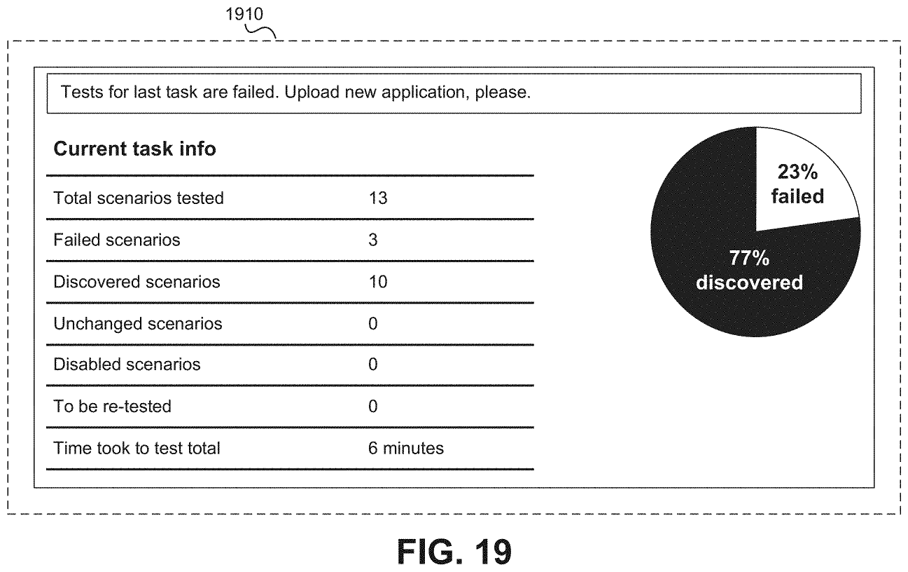

As previously discussed, automated tests can be performed again, for example, after updating the target application 132 to a newer version. FIG. 19 includes a screen 1910 showing an updated test summary for the target application 132 resulting from a retest. In this case, the retest has resulted in several failed scenarios due, for example, to a change in the target application 132. In this example, the test summary indicates that 23% of the testing scenarios resulted in a failure.

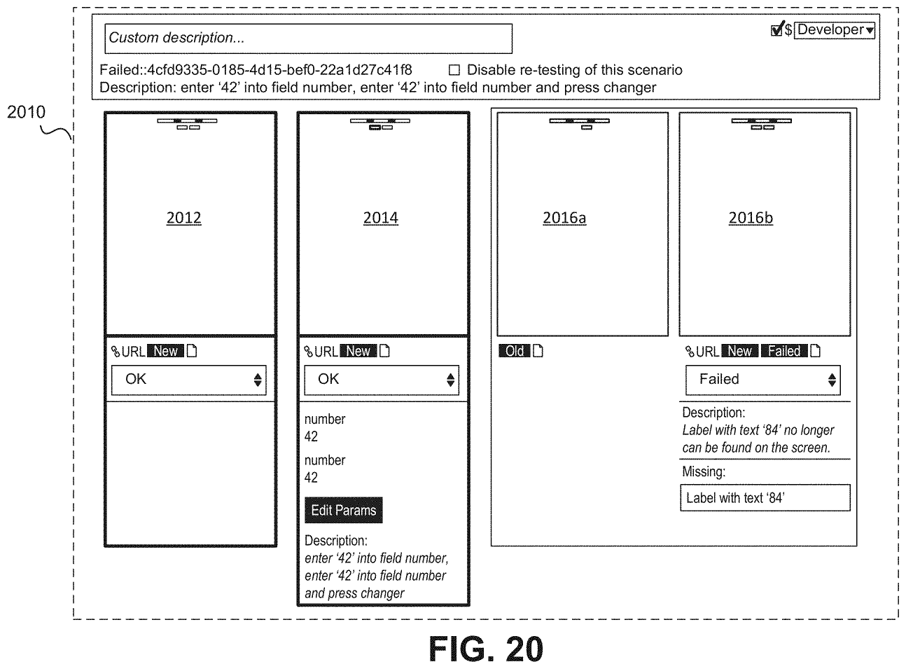

FIG. 20 includes a screen 2010 showing screen captures from the retest. As shown in FIG. 20, screen 2010 includes four total screen captures. Screen captures 2012 and 2014 are similar to screen captures 1712 and 1714 (respectively) of FIG. 17. However, screen 2010 also includes a pair of screen captures 2016a and 2016b that indicate a problem. Here, screen captures 2016a and 2016b represent a comparison between a screen capture from the initial test and a screen capture from the retest. In other words, screen capture 2016a is the same as screen capture 1716 (from FIG. 17) and screen capture 2016b shows a different state of the GUI of the target application 132 following the retest indicating that something in the test scenario is behaving differently. A developer user may review the comparison and determine, for example with the assistance of one or more visual augmentations, that the “add” button is no longer operating as expected. For example, a message is provided below screen capture 2014b indicating that the number “84” is no longer present in the screen even though it appeared in a corresponding screen during the initial test (see e.g., zoomed screen capture 1816).

What is claimed is:

1. A method comprising:
crawling, by a computer system, a graphical user interface (GUI) of a target application;
capturing, by the computer system, a screenshot the GUI while crawling the GUI;
processing, by the computer system, the screenshot of the GUI using a machine learning model; and
detecting, by the computer system, an error associated with the GUI based on the processing.

2. The method of claim 1, further comprising:
generating, by the computer system, an output based on the detected error; and
causing display, by the computer system, of the output to a developer user associated with the target application.

3. The method of claim 2, wherein the output includes the screenshot.

4. The method of claim 3, wherein the output further includes a visual augmentation displayed in proximity to a portion of the screenshot corresponding to the detected error.

5. The method of claim 1, wherein detecting the error includes determining, based on the processing, that an interactive element of the GUI is any of: broken, missing from the GUI, or in an incorrect location in the GUI.

6. The method of claim 1, wherein crawling the target application includes:
interacting, by the computer system, with one or more interactive elements of the GUI according to an automated testing scenario.

7. The method of claim 6, wherein the captured screenshot is one of a plurality of screenshots captured during a sequence of interaction with the one or more interactive elements of the GUI, the method further comprising:
processing, by the computer system, the plurality of screenshots using the machine learning model;
wherein the detected error associated with the GUI is further based on the processing of the plurality of screenshots.

8. The method of claim 6, wherein the interactive element includes any of: a button, a pull-down menu, or an editable text field.

9. The method of claim 1, wherein processing the screenshot using the machine learning model generates an error score, and wherein detecting the error associated with the GUI based on the processing includes:
determining that the error score satisfies a specified scoring criterion.

10. The method of claim 1, wherein the machine learning model is an artificial neural network.

11. The method of claim 1, wherein the machine learning model is one of a plurality of different machine learning models, each of the plurality of different machine learning models including distinct processing logic for detecting a different one of a plurality of different types of errors.

12. The method of claim 11, wherein the plurality of different types of errors include any two or more of: an interactive element that is broken, an interactive element that is missing from the GUI, or an interactive element that is in an incorrect location in the GUI.

13. The method of claim 11, further comprising:
processing, by the computer system, the screenshot of the GUI using each of the plurality of machine learning models;
wherein the detected error associated with the GUI is further based on the processing of screenshots using each of the plurality of machine learning models.

14. The method of claim 1, wherein the machine learning model is trained based on a set of labeled training images.

15. The method of claim 14, wherein the set of labeled training images includes previously captured screenshots of the GUI associated with the target application.

16. The method of claim 14, wherein the set of labeled training images includes previously captured screenshots of a GUI associated with another application that shares a characteristic with the target application.

17. The method of claim 1, further comprising:
accessing, by the computer system, a model repository including a plurality of different machine learning models, each of the plurality of different machine learning models including distinct processing logic for detecting errors in a different one of a plurality of different types of applications; and
selecting, by the computer system, the machine learning model from the plurality of different machine learning models, the machine learning model including processing logic for detecting errors in a type of application that satisfies a similarity criterion when compared to the target application.

18. A computer system comprising:
a processor; and
a memory coupled to the processor, the memory having instructions stored thereon, which when executed by the processor, cause the computer system to:
crawl a graphical user interface (GUI) of a target application;
capture a screenshot the GUI while crawling the GUI;
process the screenshot of the GUI using a machine learning model; and
detect an error associated with the GUI based on the processing.

19. The computer system of claim 18, wherein detecting the error includes determining, based on the processing, that an interactive element of the GUI is any of: broken, missing from the GUI, or in an incorrect location in the GUI.

20. A non-transitory computer-readable medium containing instructions, execution of which in a computer system causes the computer system to:
crawl a graphical user interface (GUI) of a target application;
capture a screenshot the GUI while crawling the GUI;
process the screenshot of the GUI using a machine learning model; and
detect an error associated with the GUI based on the processing.

21. The non-transitory computer-readable medium of claim 20, wherein detecting the error includes determining, based on the processing, that an interactive element of the GUI is any of: broken, missing from the GUI, or in an incorrect location in the GUI.
